(19) United States
(12) Patent Application Publication
(10) Pub. No.: US 2006/0042449 A1
(43) Pub. Date: Mar. 2, 2006

(54) Guitar saddle structure

(76) Inventor: Ping Chang, Taichung City (TW)

Correspondence Address: BIRCH STEWART KOLASCH & BIRCH, PO BOX 747, FALLS CHURCH, VA, 22040-0747, US

(21) Appl. No.: 10/930,828

(22) Filed: Sep. 1, 2004

(51) Int. Cl. G10D 3/04

(52) U.S. Cl. 84/298

(57) ABSTRACT

A guitar saddle structure includes a bridge base and a plurality of string decks. The bridge base has a plurality of housing compartments each has a ramp on the left side and the S right side. Each of the string decks has a bucking surface on the left side and the right side corresponding to the ramp. The string decks are held in the housing compartments with the bucking surface resting on and in contact with the ramp such that when the string is laid on the string deck and being played, a clear and crisp sound may be generated without the interference of vibration.

FIELD OF THE INVENTION

The present invention relates to guitar structure and particularly to a guitar saddle structure.

### BACKGROUND OF THE INVENTION

Guitar is a string instrument that must have a saddle structure to adjust the resonant length of individual strings to achieve precise tone quality. Refer to FIGS. 1A and 2 for a conventional guitar saddle structure. It includes a bridge base 10 which has a plurality of housing compartments 30. Each of the housing compartments 30 has respectively a flat surface 1 on two sides to hold a string deck 20 which has corresponding flat surfaces. The string deck 20 has a screw hole (not shown in the drawings). The bridge base 10 has a plurality of apertures (not shown in the drawings) corresponding to the screw holes to couple with adjustment screws 40. By turning the adjustment screw 40, the position of the string deck 20 may be adjusted to alter the resonant length of the string 60 after the string 60 has been laid on the string deck 20.

Referring to FIG. 1B, as deviation is unavoidable during machining, when the string deck 20 is housed in the housing compartment 30 of the bridge base 10, a clearance 2 has to be reserved to make sure that the housing compartment 30 can accommodate the string deck 20. As a result, the clearance 2 is unavoidable during fabrication. When the string 60 is laid on the string deck 20 (referring to FIG. 2) for user playing, the vibration of the string 60 will cause the string deck 20 to vibrate transversely and slightly to the left side and right side. Hence the sound generated by the guitar is not clear and crisp. Tone quality is seriously affected. In short, the conventional saddle structure of the guitar cannot anchor the string 60 steadily and generate clear and crisp sound effect.

### SUMMARY OF THE INVENTION

Therefore the primary object of the present invention is to provide a steady string anchor structure for guitar strings to generate clear and crisp sound effect during playing.

The invention aims to provide a guitar saddle structure that includes a bridge base and a plurality of string decks. The bridge base has a plurality of housing compartments each has a ramp on the left side and the right side. Each of the string decks has two bucking surfaces on two sides corresponding to the ramps. The string decks are housed in the housing compartments with the bucking surfaces in contact with ramps. The string deck also has a screw hole. The bridge base has a plurality of apertures corresponding to the screw holes of the string decks to receive an adjustment screw to engage with the screw hole.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a schematic view of a conventional guitar saddle structure.

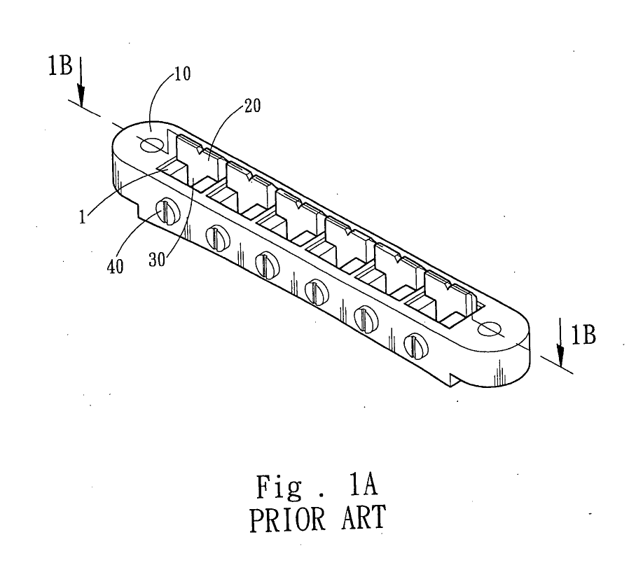

FIG. 1B is a cross section taken on line 1B-1B in FIG. 1A.

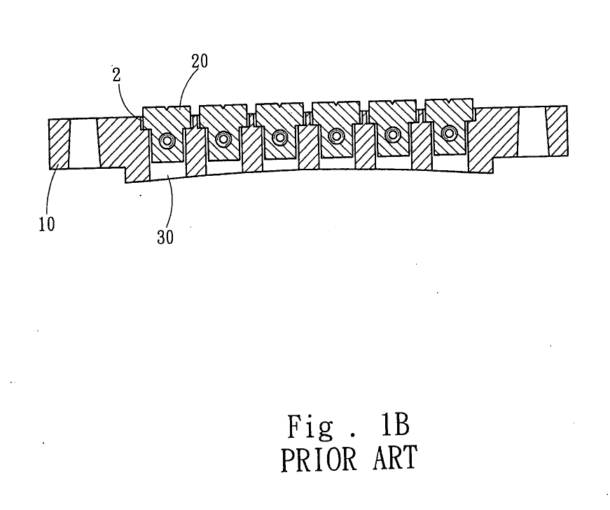

FIG. 2 is a schematic view of a conventional guitar saddle structure in an installation condition.

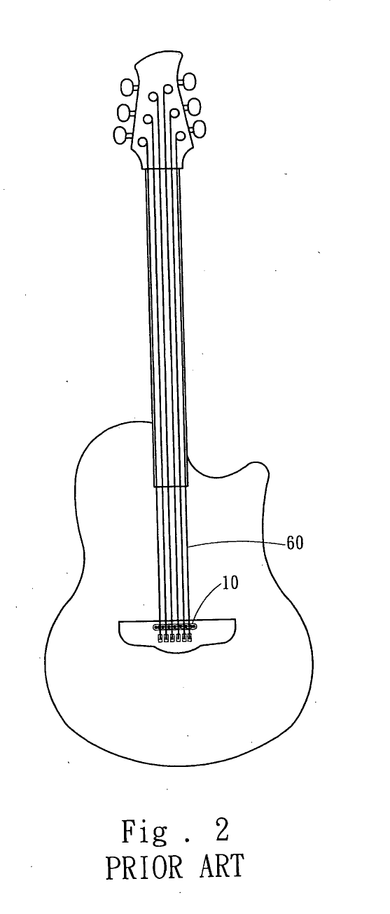

FIG. 3 is an exploded view of the invention.

FIG. 4A is a perspective view of the invention.

FIG. 4B is a cross section taken on line 4B-4B in FIG. 4A.

FIG. 5 is a schematic view of the invention in a use condition.

### DETAILED DESCRIPTION OF THE PREFERRED EMBODIMENT

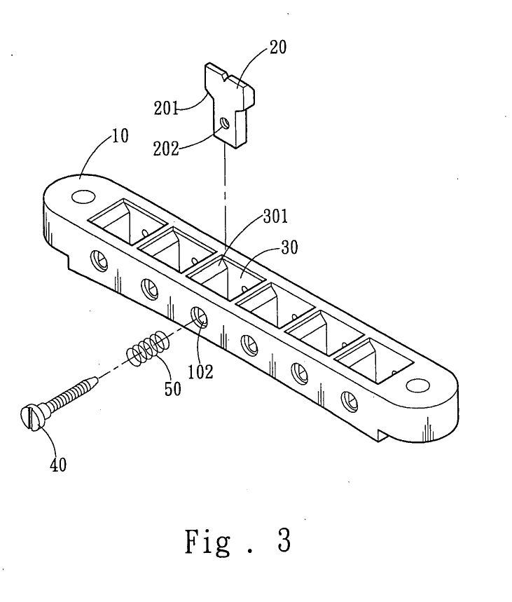

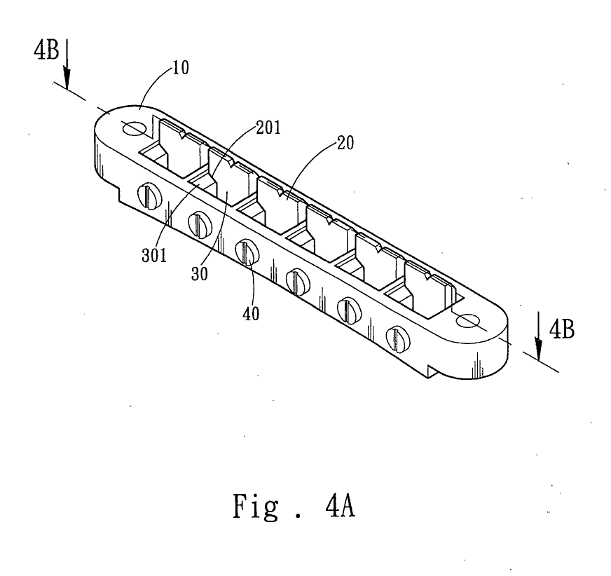

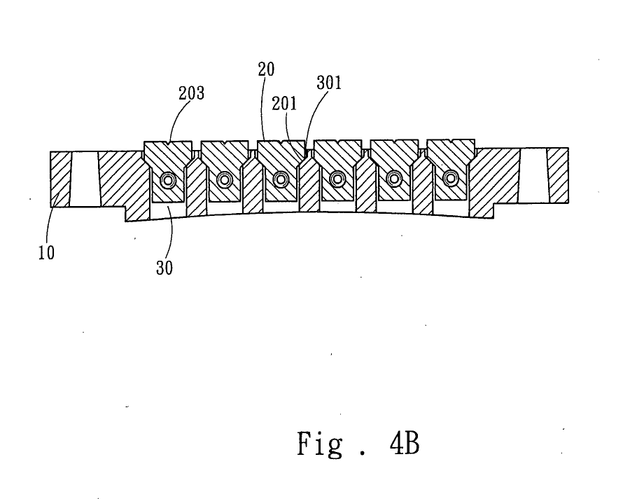

Please referring to FIGS. 3 and 4A, the guitar saddle structure according to the present invention includes a bridge base 10 and a plurality of string decks 20. The bridge base 10 has a plurality of housing compartments 30 each has a ramp 301 on the left side and the right side. Each of the string decks 20 has two bucking surfaces 201 on two sides corresponding to the ramps 301. The string decks 20 are housed in the housing compartments 30 with the bucking surfaces 201 in contact with ramps 301. The string deck 20 also has a screw hole 202. The bridge base 10 has a plurality of apertures 102 corresponding to the screw holes 202 of the string decks 20 to respectively receive an adjustment screw 40 to couple with the screw hole 202. The adjustment screw 40 further is coupled with a spring 50 which is located between the string deck 20 and the bridge base 10 to increase the steadiness of the adjustment screw 40.

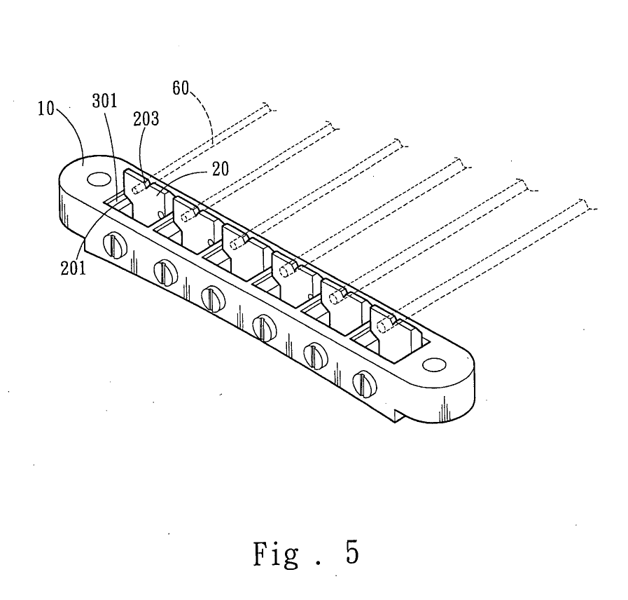

Referring to FIGS. 4B and 5, the string deck 20 is installed in the housing compartments 30 with the bucking surface 201 resting on the ramps 301. When the string 60 is laid on the string deck 20, it exerts a downward force on the string deck 20 to keep the string deck 20 in close contact with the housing compartment 30, and the ramps 301 also are in close contact with the bucking surfaces 201 to hold the string deck 20 on two sides. Thus transverse vibration of the string deck 20 may be eliminated. The bridge base 10 can hold a plurality of string decks 20. To install a plurality of strings 60, a conventional guitar has six string decks 20. And each string deck 20 has an anchor notch 203 formed in the middle portion of the top end to anchor the string 60 securely.

By means of the construction set forth above, when the string 60 is played, the string deck 20 is held firmly without vibrating due to its two sides are clamped by the ramp 301. Thus the invention can generate clear and crisp sound effect.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A guitar saddle structure comprising a bridge base which has a plurality of housing compartments and a plurality of string decks, characterized in:
each of the housing compartments having a ramp on a left side and a right side thereof, each of the string decks having a bucking surface on a left side and a right side corresponding to the ramp, the string decks being held in the housing compartments with the bucking surface resting on and in contact with the ramp.

2. The guitar saddle structure of claim 1, wherein the string decks have respectively a screw hole, and the bridge base has a plurality of apertures corresponding to the screw hole to couple with an adjustment screw to engage with the screw hole.

3. The guitar saddle structure of claim 2, wherein the adjustment screw is coupled with a spring which is located between the string deck and the bridge base.

4. The guitar saddle structure of claim 1, wherein each of the string decks has an anchor notch.
